(19) United States
(12) Patent Application Publication
(10) Pub. No.: US 2013/0219272 A1
(43) Pub. Date: Aug. 22, 2013

(54) MONITORING AND GUIDING USER INPUT AMONG MULTIPLE COMPUTER PROGRAM USER INTERFACES

(71) Applicants: Swaminathan Balasubramanian, Troy, MI (US); Andrew R. Jones, Round Rock, TX (US); Brian M. O'Connell, Research Triangle Park, NC (US)

(72) Inventors: Swaminathan Balasubramanian, Troy, MI (US); Andrew R. Jones, Round Rock, TX (US); Brian M. O'Connell, Research Triangle Park, NC (US)

(73) Assignee: INTERNATIONAL BUSINESS MACHINES CORPORATION, Armonk, NY (US)

(21) Appl. No.: 13/402,512

(22) Filed: Feb. 22, 2012

(51) Int. Cl. G06F 3/01

(52) U.S. Cl. 715/704

(57) ABSTRACT

An example method includes a device recording a user input as a recorded user input associated with a first computer program user interface, and providing a display output comprising a first display output for the first computer program user interface and a second display output for a second computer program user interface. The device receives a current user input via a user input device while the second user interface is currently configured to receive user inputs, and while the first user interface is not currently configured to receive user inputs. The device determines that the current user input matches the recorded user input, and in response, the device prevents the current user input from being received by the second computer program user interface and provides the current user input to the first computer program user interface.

### TECHNICAL FIELD

The disclosure relates to user interfaces in computing systems, and particularly to computing devices running multiple computer programs and/or multiple instances of a computer program, each of the multiple computer programs and/or multiple computer program instances having at least one computer program user interface.

### BACKGROUND

Typically, a user interacts with computer programs running or being executed on a computing device through one or more user input devices, such as a keyboard, a mouse or other pointer device, or a touchpad. Often, a user uses the keyboard more than any other input device to enter inputs to a user interface for a computer program. A few keyboard inputs, such as alt-tab, may be reserved by the operating system, but other than that, all keyboard inputs are generally delivered to a computer program user interface that the user has open for a computer program currently running on the computing device.

The ever-increasing availability of high-performance computing devices has made it ever more commonplace for a user to have several different computer programs or several instances of computer programs executing simultaneously on a computing device. When several computer programs or several instances of computer programs or applications are executing at the same time on one computing device, one of the computer program's or instance's user interfaces at a time is considered to be in focus, while the others are out of focus. Focus in this sense refers to which computer program user interface is currently selected or configured to receive user inputs through user input devices such as a keyboard and mouse, other than some user input that is reserved by the operating system or otherwise performs an action outside the computer program user interface or changes the focus. User inputs that are reserved to go outside of the in-focus computer program user interface may include keystrokes on the keyboard on an operating system menu key, a “print screen” key, and simultaneous keystrokes on the alt key and the tab key, for example. Graphical user interface windows of different, out-of-focus computer program user interfaces may appear outside a user interface window of a currently in-focus computer program user interface, either on the same monitor, or on a different monitor in a computing environment where a user has multiple monitors connected to a single computing device.

### SUMMARY

In one example, a method includes a computing device recording, in one or more computer-readable tangible storage devices, a user input as a recorded user input associated with a first computer program user interface. At least one of one or more processors of the computing device provides a display output to one or more display devices, the display output comprising a first display output for the first computer program user interface and a second display output for a second computer program user interface. The computing device receives a current user input via a user input device while the second computer program user interface is currently configured to receive user inputs via the user input device, and while the first computer program user interface is not currently configured to receive user inputs via the user input device. The at least one of the one or more processors of the computing device determines that the current user input matches the recorded user input, and in response, the at least one of the one or more processors of the computing device prevents the current user input from being received by the second computer program user interface, and the at least one of the one or more processors of the computing device provides the current user input to the first computer program user interface.

In another example, a computing system includes one or more processors, one or more computer-readable tangible storage devices, one or more display devices, one or more user input devices, and program instructions, stored on at least one of the one or more computer-readable tangible storage devices for execution by at least one of the one or more processors. The computing system includes program instructions, stored on at least one of the one or more computer-readable tangible storage devices for execution by at least one of the one or more processors, to record, in at least one of the one or more computer-readable tangible storage devices, a user input as a recorded user input associated with a first computer program user interface. The computing system further includes program instructions, stored on at least one of the one or more computer-readable tangible storage devices for execution by at least one of the one or more processors, to provide a display output to at least one of the one or more display devices, the display output comprising a first display output for the first computer program user interface and a second display output for a second computer program user interface. The computing system further includes program instructions, stored on at least one of the one or more computer-readable tangible storage devices for execution by at least one of the one or more processors, to receive a current user input via at least one of the one or more user input devices while the second computer program user interface is currently configured to receive user inputs via the at least one of the one or more user input devices, and while the first computer program user interface is not currently configured to receive user inputs via the at least one of the one or more user input devices. The computing system further includes program instructions, stored on at least one of the one or more computer-readable tangible storage devices for execution by at least one of the one or more processors, to determine that the current user input matches the recorded user input, and in response, to prevent the current user input from being received by the second computer program user interface and to provide the current user input to the first computer program user interface.

In another example, a computer program product includes one or more computer-readable tangible storage devices and program instructions stored on at least one of the one or more computer-readable tangible storage devices. The computer program product includes program instructions, stored on at least one of the one or more computer-readable tangible storage devices, to record, in at least one of the one or more computer-readable tangible storage devices, a user input as a recorded user input associated with a first computer program user interface. The computer program product further includes program instructions, stored on at least one of the one or more computer-readable tangible storage devices, to provide a display output to at least one of one or more display devices, the display output comprising a first display output for the first computer program user interface and a second display output for a second computer program user interface. The computer program product further includes program instructions, stored on at least one of the one or more computer-readable tangible storage devices, to receive a current user input via at least one of one or more user input devices while the second computer program user interface is currently configured to receive user inputs via the at least one of the one or more user input devices, and while the first computer program user interface is not currently configured to receive user inputs via the at least one of the one or more user input devices. The computer program product further includes program instructions, stored on at least one of the one or more computer-readable tangible storage devices, to determine that the current user input matches the recorded user input, and in response, to prevent the current user input from being received by the second computer program user interface and to provide the current user input to the first computer program user interface.

The details of one or more embodiments are set forth in the accompanying drawings and the description below. Other features, objects, and advantages will be apparent from the description and drawings, and from the claims.

### BRIEF DESCRIPTION OF THE SEVERAL VIEWS OF THE DRAWINGS

FIG. 1 is a block diagram of a computing device that may run a user input guidance agent, according to an illustrative example.

FIG. 2 is a system diagram of a computing device that may run a user input guidance agent, according to an illustrative example.

FIGS. 3A and 3B depict a personal computing environment running a user input guidance agent, according to an illustrative example.

FIG. 4 is a flowchart illustrating operation of a method for a user input guidance agent, according to an illustrative example.

FIG. 5 is a flowchart illustrating operation of a method for a user input guidance agent, according to an illustrative example.

FIG. 6 is a block diagram of a computing network environment in which a user input guidance agent may be used, according to an illustrative example.

### DETAILED DESCRIPTION

There are set forth herein examples of a method, system, and computer program product for monitoring and guiding user inputs between multiple computer program user interfaces running on a computing device or in a computing environment. Various embodiments disclosed herein may enable monitoring, confirming, and redirecting user inputs and focus, among various other features and advantages.

Embodiments of the present invention recognize that, depending on particular computer programs and the appearance of their user interfaces, lighting conditions, operating system, and operating system theme or skin, it may be difficult at times to discern which computer program user interface is currently in focus. Embodiments of the present invention further recognize that, sometimes, through inadvertent action or action that the user has taken but not kept track of, one computer program user interface may capture focus while the user believes a different computer program user interface is in focus. A user may begin entering inputs to what the user believes is the in-focus computer program user interface, only to have the inputs entered into the other computer program user interface that actually has the focus. This may interrupt the user's work flow and distract the user at best, or potentially cause significant unwanted or even destructive changes of state to the computer program to which the user input is inadvertently sent.

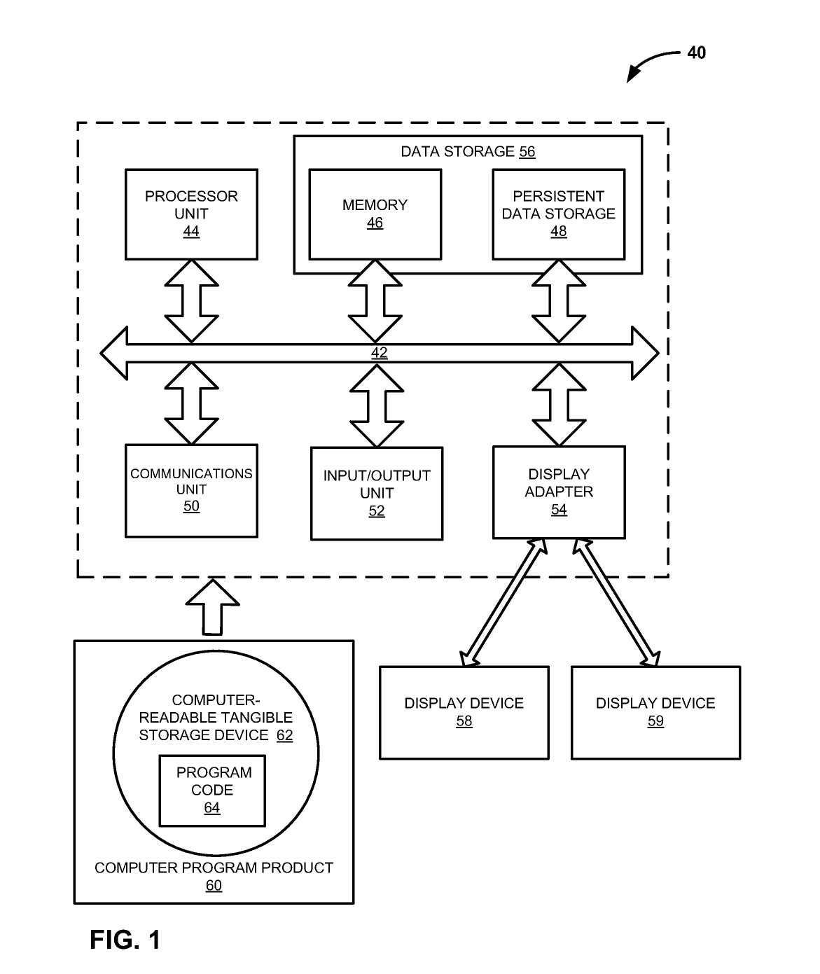

Various implementations of a user input guidance agent as disclosed herein may prevent such inadvertent user inputs to an unintended computer program user interface. An implementation of a user input guidance agent may, for example, perform evaluate whether a user input is likely to be intended for entry into a currently in-focus computer program user interface. In this example, the user input guidance agent may also compare the relative likelihood of a user input being intended for entry into a currently in-focus computer program user interface versus one or more other computer program user interfaces that are currently displayed but not in focus. The user input guidance agent may also, for example, take the current state of the display devices into account, and monitor for inputs that may be intended for entry into computer program user interfaces that are currently out of focus but are currently being displayed on a monitor, while it disregards the likelihood of a user input being intended for entry into a computer program without a computer program user interface currently being displayed on a monitor. Various illustrative features and advantages of a user input guidance agent are further described below with reference to FIGS. 1-6.

FIG. 1 is a block diagram of a computing device that may run a user input guidance agent, according to an illustrative example. FIG. 1 depicts an illustrative computing device 40 that embodies or implements examples of a user input guidance agent. Computing device 40 may be a workstation, server, mainframe computer, notebook or laptop computer, desktop computer, tablet, smartphone, feature phone, or other programmable data processing apparatus of any kind. Other possibilities for computing device 40 are possible, including a computer having capabilities other than or beyond those described herein.

In this illustrative example, computing device 40 includes communications fabric 42, which provides communications between processor unit 44, memory 46, persistent data storage 48, communications unit 50, and input/output (I/O) unit 52. Communications fabric 42 may include a dedicated system bus, a general system bus, multiple buses arranged in hierarchical form, any other type of bus, bus network, switch fabric, or other interconnection technology. Communications fabric 42 can support transfer of data, commands, and other information between various subsystems of computing device 40.

Processor unit 44 may include a programmable central processing unit (CPU) configured for executing programmed instructions stored in memory 46. Further, processor unit 44 may be implemented using one or more heterogeneous processor systems in which a main processor is present with secondary processors on a single chip. As another illustrative example, processor unit 44 may be a symmetric multi-processor system containing multiple processors of the same type. Processor unit 44 may include a reduced instruction set computing (RISC) microprocessor such as a PowerPC® processor from IBM® Corporation, an x86 compatible processor such as a Pentium® processor from Intel® Corporation, an Athlon® processor from Advanced Micro Devices® Corporation, or any other suitable processor. In various examples, processor unit 44 may include a multi-core processor, such as a dual core or quad core processor, for example. Processor unit 44 may include multiple processing chips on one die, and/or multiple dies on one package or substrate, for example. Processor unit 44 may also include one or more levels of integrated cache memory, for example. In various examples, processor unit 44 may comprise one or more CPUs distributed across one or more locations.

Data storage 56 includes memory 46 and persistent data storage 48, which are in communication with processor unit 44 through communications fabric 42. Memory 46 and persistent data storage 48 each constitute a computer-readable tangible storage device. Memory 46 can include a random access semiconductor memory (RAM) for storing application data, i.e., computer program data, for processing. While memory 46 is depicted conceptually as a single monolithic entity, in various examples, memory 46 may be arranged in a hierarchy of caches and in other memory devices, in a single physical location, or distributed across a plurality of physical systems in various forms. While memory 46 is depicted physically separated from processor unit 44 and other elements of computing device 40, memory 46 may refer equivalently to any intermediate or cache memory at any location throughout computing device 40, such as cache proximate to or integrated with processor unit 44 or individual cores of processor unit 44.

Persistent data storage 48 may include one or more hard disc drives, solid state drives, flash drives, rewritable optical disc drives, magnetic tape drives, or any combination of these or other data storage device. Persistent data storage 48 may store computer-executable instructions or computer-readable program code for an operating system, program code 64, application files comprising program code, data structures or data files, and any other type of data. These computer-executable instructions may be loaded from persistent data storage 48 into memory 46 to be read and executed by processor unit 44 or other processors. Data storage 56 may also include any other hardware elements capable of storing information, such as, for example and without limitation, data, program code in functional form, and/or other suitable information, either on a temporary basis and/or a permanent basis.

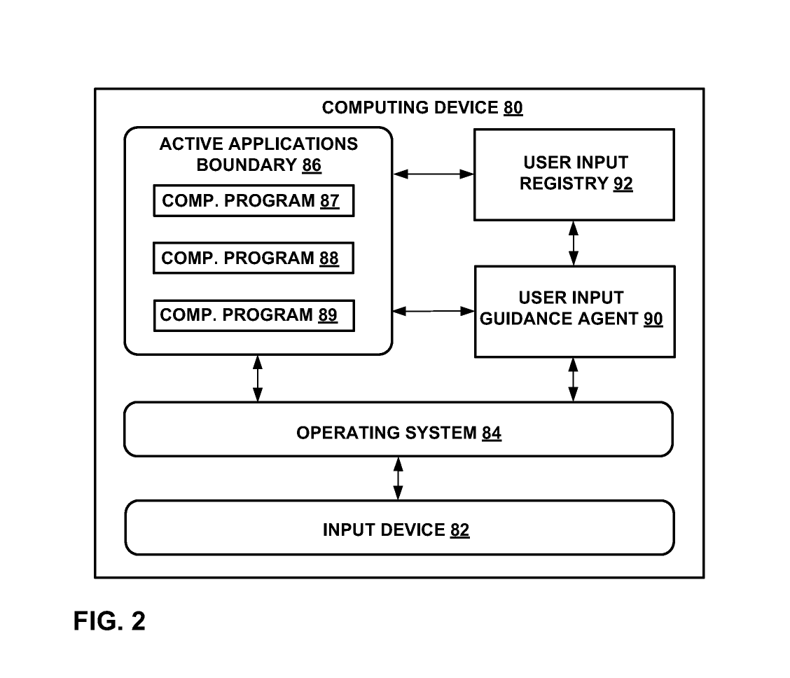

The operating system may provide functions such as device interface management, memory management, and multiple task management. The operating system can be a Unix based operating system such as the AIX® operating system from IBM® Corporation, a non-Unix based operating system such as the Windows® family of operating systems from Microsoft® Corporation, a network operating system such as JavaOS® from Oracle® Corporation, a mobile device operating system such as iOS® from Apple® Inc., or any other suitable operating system. Processor unit 44 can be suitably programmed to read, load, and execute instructions of the operating system. Processor unit 44 can also be suitably programmed to read, load, and execute instructions for a user input guidance agent, such as user input guidance agent 90 shown in FIG. 2, that may monitor and guide user inputs between multiple computer program user interfaces for multiple computer programs and/or multiple computer program instances running on a computing device, as described in greater detail below.

Communications unit 50, in this example, provides for communications with other computing or communications systems or devices. Communications unit 50 may provide communications through the use of physical and/or wireless communications links. Communications unit 50 may include a network interface card for interfacing with a LAN, an Ethernet adapter, a Token Ring adapter, a modem for connecting to a transmission system such as a telephone line, or any other type of communication interface. Communications unit 50 can be used for operationally connecting many types of peripheral computing devices to computing device 40, such as printers, bus adapters, and other computers. Communications unit 50 may be implemented as an expansion card or be built into a motherboard, for example.

The input/output unit 52 can support devices suited for input and output of data with other devices that may be connected to computing device 40, such as keyboard, a mouse or other pointer, a touchscreen interface, an interface for a printer or any other peripheral device, a removable magnetic or optical disc drive (including CD-ROM, DVD-ROM, or Blu-Ray), a universal serial bus (USB) receptacle, or any other type of input and/or output device. Input/output unit 52 may also include any type of interface for video output in any type of video output protocol and any type of monitor or other video display technology, in various examples. It will be understood that some of these examples may overlap with each other, or with example components of communications unit 50 or data storage 56. Input/output unit 52 may also include appropriate device drivers for any type of external device, or such device drivers may reside elsewhere on computing device 40 as appropriate.

Computing device 40 also includes a display adapter 54 in this illustrative example, which provides one or more connections for one or more display devices, such as display devices 58 and 59, which may include any of a variety of types of display devices. It will be understood that some of these examples may overlap with example components of communications unit 50 or input/output unit 52. Input/output unit 52 may also include appropriate device drivers for any type of external device, or such device drivers may reside elsewhere on computing device 40 as appropriate. Display adapter 54 may include one or more video cards, one or more graphics processing units (GPUs), one or more video-capable connection ports, or any other type of data connector capable of communicating video data, in various examples. Display devices 58, 59 may be any kind of video display device, such as a monitor, a television, or a projector, in various examples.

Input/output unit 52 may include a drive, socket, or outlet for receiving computer program product 60, which comprises one or more computer-readable tangible storage devices 62 and computer program code 64 stored on at least one of one or more computer-readable tangible storage devices 62. For example, one or more computer-readable tangible storage devices 62 may include a CD-ROM, a DVD-ROM, a Blu-Ray disc, a magnetic disc, a USB stick, a flash drive, or an external hard disc drive, as illustrative examples, or any other suitable data storage devices. In various examples, program code 64 may include program code of user input guidance agent 90 shown in FIG. 2.

One or more computer-readable tangible storage devices 62 may include any type of optical, magnetic, or other physical storage device that physically encodes program code 64 as a binary series of different physical states in each unit of memory that, when read by computing device 40, induces a physical signal that is read by processor 44 that corresponds to the physical states of the storage device, and that induces corresponding changes in the physical state of processor unit 44. That physical program code signal may be modeled or conceptualized as computer-readable instructions at any of various levels of abstraction, such as a high-level programming language, assembly language, or machine language, but ultimately constitutes a series of physical electrical and/or magnetic structural interactions that physically induce a change in the physical state of processor unit 44, thereby physically causing processor unit 44 to generate physical outputs in accordance with the computer-executable instructions, in a way that causes computing device 40 to physically assume new capabilities that it did not have until its physical state was changed by loading the executable instructions comprised in program code 64.

In some illustrative examples, program code 64 may be downloaded over a network to persistent storage 48 from another device or computer system for use within computing device 40. Program code 64 comprising computer-executable instructions may be communicated or transferred to computing device 40 from at least one of one or more computer-readable tangible storage devices 62 through a hard-line or wireless communications link to communications unit 50 and/or through a connection to input/output unit 52. At least one of one or more computer-readable tangible storage devices 62 comprising program code 64 may be located at a separate or remote location from computing device 40, and may be located anywhere, including at any remote geographical location anywhere in the world, and may relay program code 64 to computing device 40 over any type of one or more communication links, such as the Internet and/or other packet data networks. The program code 64 may be transmitted over a wireless Internet connection, or over a shorter-range direct wireless connection such as wireless LAN, Bluetooth™, Wi-Fi™, or an infrared connection, for example. Any other wireless or remote communication protocol may also be used in other implementations.

The communications link and/or the connection may include physical and/or wireless connections in various illustrative examples, and program code 64 may be transmitted from at least one of one or more computer-readable tangible storage devices 62 over non-tangible media, such as communications links or wireless transmissions containing the program code 64. Program code 64 may be more or less temporarily or durably stored on any number of intermediate tangible, physical computer-readable devices and media, such as any number of physical buffers, caches, main memory, or data storage components of servers, gateways, network nodes, mobility management entities, or other network assets, en route from its original source medium to computing device 40.

FIG. 2 is a system diagram of a computing device that may run a user input guidance agent, according to an illustrative example. Computing device 80 shown in FIG. 2 may be implemented on computing device 40 of FIG. 1 or other computing device, or in a computing environment with multiple computing devices, in various examples. Computing device 80 includes an input device 82, such as a keyboard, that receives user inputs, most of which are conveyed by operating system 84 across active applications boundary 86 to computer programs 87, 88, and 89, in the representative state depicted here, and which may include any number of computer programs being executed in a computing environment, in other examples. Computer programs 87, 88, and 89 are computer programs running, i.e., being executed, on computing device 80, each of which may have an associated computer program user interface displayed on a display device. Computer programs 87, 88, and 89 are all active, i.e., they are loaded into the computer's memory and are available to receive user input. Each of computer programs 87, 88, and 89 has at least one associated user interface that includes a display output, such as a graphical user interface window, widget, or other graphical user interface element, that may be displayed on a display device, and has corresponding input methods for receiving user inputs. A computer program user interface may include any aspect of a computer program or an instance of a computer program for receiving user inputs or for providing user-perceptible outputs.

One or more of computer programs 87, 88, 89 may have multiple instances running, where each instance has its own computer program user interface, such that a user may select from among different computer program user interfaces for different instances of the computer program with which instance the user wants to interact. For example, a user may have two different graphical user interface windows open for the same web browser computer program. In this case, each of the graphical user interface windows for the same web browser computer program may be a separate computer program user interface. At any one point in time, only one of the computer program user interfaces for any of computer programs 87, 88, and 89 is currently in focus and enabled to receive user inputs, except by intervention of user input guidance agent 90.

Computing device 80 also includes user input guidance agent 90, as well as user input registry 92. User input guidance agent 90 uses user input registry 92 to record and index keystrokes, sequences of keystrokes or other combinations of keystrokes, or other user inputs or patterns of user input. User input guidance agent 90 may also use user input registry 92 to record associations between certain user inputs or user input patterns and the corresponding computer program user interfaces to which those user inputs are intended to be entered. User input guidance agent 90 may also record metadata associated with patterns of user input in some cases, such as time intervals in which selected sequences or patterns of user input may be entered.

The associations between user inputs and corresponding computer program user interfaces, as recorded by user input guidance agent 90, may include transient associations and configured associations, for example. For the transient associations, when a computer program user interface receives input focus, user input guidance agent 90 may collect any user inputs, such as short-cut keystroke sequences that are used with already active computer programs. The configured associations may include common keystroke sequences or other combinations of keystrokes associated with common usage of specific computer programs. User input guidance agent 90 may reassign new sequences for the common sequences. As a user interacts with one or more of computer programs 87, 88, and 89, user input guidance agent 90 receives user inputs such as keystroke sequences to be delivered to the computer program user interface currently in focus.

User input guidance agent 90 may determine whether a current user input matches one of the recorded user inputs. The current user input may be a single input, a simultaneous combination of inputs, or a time-ordered sequence of inputs, for example, and the recorded user inputs may include instances of single inputs, simultaneous combinations of inputs, and time-ordered sequences of inputs, including an instance of a recorded user input that matches the current user input. If user input guidance agent 90 determines that the current user input does match a recorded user input, then user input guidance agent 90 may take certain actions in response. For example, user input guidance agent 90 may prevent the current user input from being received by the computer program user interface that is currently in focus. User input guidance agent 90 may also provide the current user input to the computer program user interface associated with a recorded user input that matches the current user input. User input guidance agent 90 may also, for example, detect whether a sequence of user inputs is received in an amount of time that is outside a threshold range of time, or of a time period, for entering the sequence of user inputs, and if so, then cause the sequence of user inputs to be ignored.

In one illustrative example, user input guidance agent 90 records user inputs in user input registry 92, which may be physically implemented in a data structure stored in memory 46 or another memory component in data storage 56 in FIG. 2, for example. The user inputs recorded in user input registry 92 include user inputs for accessing features of a first computer program user interface for a first computer program or a first instance of the first computer program, such as computer program 87. The computer program user interface for computer program 87 may include a display output of a graphical user interface (GUI) element such as a graphical user interface window, for example. Each of any number of other computer programs or computer program instances executing at the same time, such as computer programs 88 and 89, or one or more additional instances of computer program 87, may have their own separate computer program user interfaces, with their own windows or other GUI elements, or tabbed user interfaces in an integrated graphical window, for example.

User input guidance agent 90 may therefore analyze user input and predictively determine the intended recipient computer program user interface. User input guidance agent 90 may use any of a wide variety of information to make this determination. For example, user input guidance agent 90 may analyze user interaction history to determine if an input sequence has been frequently associated with a particular computer program user interface in the past. As another example, user input guidance agent 90 may receive and record in user input registry 92 user inputs defining customizations or selectable configurations indicating that a particular user input, including an individual input or a sequence of inputs, is to be associated with a particular computer program user interface, even if that computer program user interface may not currently be in focus. In another example, user input guidance agent 90 may use computer program user interface activity history to determine if a computer program user interface currently configured to receive input has received focus within a threshold period of time prior to entry of a user input. In yet another example, user input guidance agent 90 may analyze and use a user interactivity rate to determine if the rate at which a user input sequence is entered by the user is above or below a certain threshold, indicating that the user input sequence was likely unintended, at least for the computer program user interface currently in focus, and should be redirected or ignored.

User input guidance agent 90 may therefore use recorded user input data, such as interaction history, to redirect user inputs to a particular computer program user interface when those user inputs are particularly indicated for being associated with that particular computer program user interface, even when that computer program user interface is not in focus. User input guidance agent 90 may also record user input customizations and use them to determine if a user input is intended for entry into a different computer program user interface than the one currently in focus, thereby preventing unintended alterations or changes in state to a computer program associated with that computer program user interface. User input guidance agent 90 may also use computer program user interface activity history and interactivity rate in combination to either reject or redirect user inputs that a user intended for entry into a different computer program user interface than the one currently in focus in response to receiving the user inputs.

For user input guidance agent 90 analyzing user interaction history, user input guidance agent 90 may identify functions of a computer program user interface that the user commonly invokes and the user inputs associated with the identified functions, such as keystroke sequences. User input guidance agent 90 may record this information of the user inputs associated with the identified functions, along with additional information such as the rate at which the user inputs are entered, in user input registry 92. At a later time, the user may enter the same user inputs again, potentially at a substantially matching rate of input (if applicable), and the user input guidance agent 90 may evaluate the user inputs as the user inputs are received and determine that the user inputs doe match the recorded user inputs. If other information such as the rate of input of the user inputs is also recorded, the user input guidance agent 90 may also evaluate those factors too, such as whether the user inputs were received at a frequency that exceeds a threshold. The threshold may include a minimum and/or a maximum period of time for a sequence of user inputs to be entered, and the user input guidance agent 90 may evaluate whether the frequency exceeds either of these thresholds by the user inputs being entered in less than the minimum period of time or in greater than the maximum period of time.

Therefore, user input guidance agent 90, running on a processor of computing device 80, may measure a frequency with which various user inputs are entered to computer program user interfaces for computer programs 87, 88, and 89 over time. User input guidance agent 90 may identify various user inputs as being received with a frequency that exceeds a threshold, and record the user inputs that are received with the frequency that exceeds the threshold as recorded user inputs for entering in the respective computer program user interfaces for the corresponding one of computer programs 87, 88, and 89.

If user input guidance agent 90 determines that a current user input does match a recorded user input, and the computer program user interface associated with the recorded user input is currently running but that computer program user interface is currently not configured to receive user inputs, i.e., that computer program user interface is currently not in focus, then user input guidance agent 90 may prevent the current user input from being received by the in-focus computer program user interface, and provide the current user input instead to the computer program user interface with the matching recorded user input. To do this, user input guidance agent 90 may switch the focus from the computer program user interface that previously had focus to the computer program user interface associated with the recorded user input, for the latter computer program user interface to receive the user input.

User input guidance agent 90 may leave the focus on the newly in-focus computer program user interface after the current user input is entered into the newly in-focus computer program user interface, or switch the focus back to the previous computer program user interface, in different examples. That is, user input guidance agent 90 may configure the newly in-focus computer program user interface to receive user inputs subsequent to the current user input via the user input device instead of the previously in-focus computer program user interface, or user input guidance agent 90 may configure the previously in-focus computer program user interface to receive user inputs subsequent to the current user input via the user input device after providing the current user input to the computer program user interface for which the current user input was intended. User input guidance agent 90 may also either switch focus and divert the user input to the different computer program user interface automatically, or provide a prompt first and wait for confirmation before entering the current user input to either computer program user interface, in different examples. User input guidance agent 90 may allow the user to select which of these options to enable.

User input guidance agent 90 may enable a user to enter user inputs and designate associated computer program user interfaces for which they are intended, for direct user customization as opposed to user input guidance agent 90 analyzing and learning user interaction history. User input guidance agent 90 may use either or both of these options to record in user input registry 92 the entered user inputs and the designated computer program user interfaces to which to enter user inputs matching the recorded entered user inputs. A user may supply a user input sequence, such as a keystroke sequence, along with the user's preferred computer program user interface with which to associate the user input sequence. User input guidance agent 90 may then follow the same process with these directly designated user input sequences as with user inputs recorded through learning the user interaction history, of monitoring for them and then diverting them to the intended computer program user interfaces. User input guidance agent 90 may therefore record user inputs in user input registry 92 indicating selections of user-selectable options to enter certain user inputs in certain computer program user interfaces, regardless of whether a certain computer program user interface is currently in focus and configured to receive user inputs via a user input device.

User input guidance agent 90 may also take into account the user's activity history with the computer program user interfaces as part of determining a computer program user interface for which a current user input is intended. For example, user input guidance agent 90 may determine if a current user input occurred just after, or within a certain period of time of when, a given computer program user interface was brought into focus. In one example, user input guidance agent 90 may be active in making determinations of which computer program user interface to direct a current user input to only during this transitional period within a certain margin of time of the user changing focus between different computer program user interfaces.

For example, a user may be interacting mainly with a first computer program user interface, but may alternate focus quickly to another computer program user interface to enter an input to it, such as to access a feature of it, before quickly returning to the first computer program user interface. This may frequently be the case, for example, with certain “web 2.0” applications, in which a non-RESTful web application (i.e., a web application that includes features implemented with AJAX, JSON, or other “web 2.0” technology that does not conform to representational state transfer (REST)) is running in a web browser computer program, and provides features, such as news, stock quotes, social media updates, etc., that may be rapidly accessed or updated with a rapid user input and without requiring a reload of a full web page. This may also be applicable in a wide variety of other types of applications, in which the recorded user input is for accessing a feature of the computer program, and providing the current user input to that computer program includes accessing the feature of that computer program. The user may engage in a rapid alteration of focus between different computer program user interfaces along with a rapid entry of user inputs, but may be off with the timing of the inputs, so that the user input, or part of sequential user inputs, is actually received just before or just after the user makes a switch in focus between the computer program user interfaces. The combination of this proximity in time to a user-controlled focus switch, with a user input that is shown to match a recorded user input indicated to match a user input distinctive to one of the computer program user interfaces involved in the rapid focus switch, may be used as a reliable indication of which of the two computer program user interfaces the user input was intended for entry, so that user input guidance agent 90 automatically directs the user input to that intended computer program user interface.

User input guidance agent 90 may also take into account the user's interactivity rate, such as the duration of a period of time in which the user enters a sequence of user inputs. User input guidance agent 90 may use this information on the user's interactivity rate in combination with the activity history, such as by conditioning a redirection of the sequence on both the duration of time since the user switched focus and the duration of time that the user enters the sequence. For example, user input guidance agent 90 may determine whether the user had switched focus within a certain period of time. User input guidance agent 90 may also determine whether the user had entered a sequence of user inputs at a rate above a certain threshold, or in a period of time within a certain range of periods of time for the sequence of user inputs to be received, as recorded in association with the recorded user input. User input guidance agent 90 may use a combination of these conditions as prerequisites for determining whether the user input matches a recorded user input for entering in a specified computer program user interface, in one example.

In the example depicted in FIG. 2, user input guidance agent 90 is a separate computer program that runs outside active applications boundary 86, with its own separate interface with both operating system 84 and active applications boundary 86. This separate interface enables user input guidance agent 90 to monitor and record data on user inputs to any computer program user interfaces running within active applications boundary 86, and to interrupt and redirect user inputs that operating system 84 would otherwise provide to one of the computer program user interfaces for one of the computer programs running within active applications boundary 86 based naively on whichever computer program user interface was currently in focus.

In another example, user input guidance agent 90 or the functionality thereof may be implemented at a higher level of abstraction, and may reside within operating system 84 itself or run as a process or module within operating system 84. Operating system 84, performing a user input guidance process, may analyze what user inputs, such as sets of keystrokes and the rate at which they are entered, are commonly entered to different computer program user interfaces, and record these user inputs with their associated computer program user interfaces in a user input registry. Operating system 84 may monitor for user inputs, including aspects such as keystroke sequences and rates of input, that match the recorded user inputs in its user input registry, and evaluate and redirect the user inputs as discussed above, including the option for providing a user prompt to confirm a proposed redirecting of a user input.

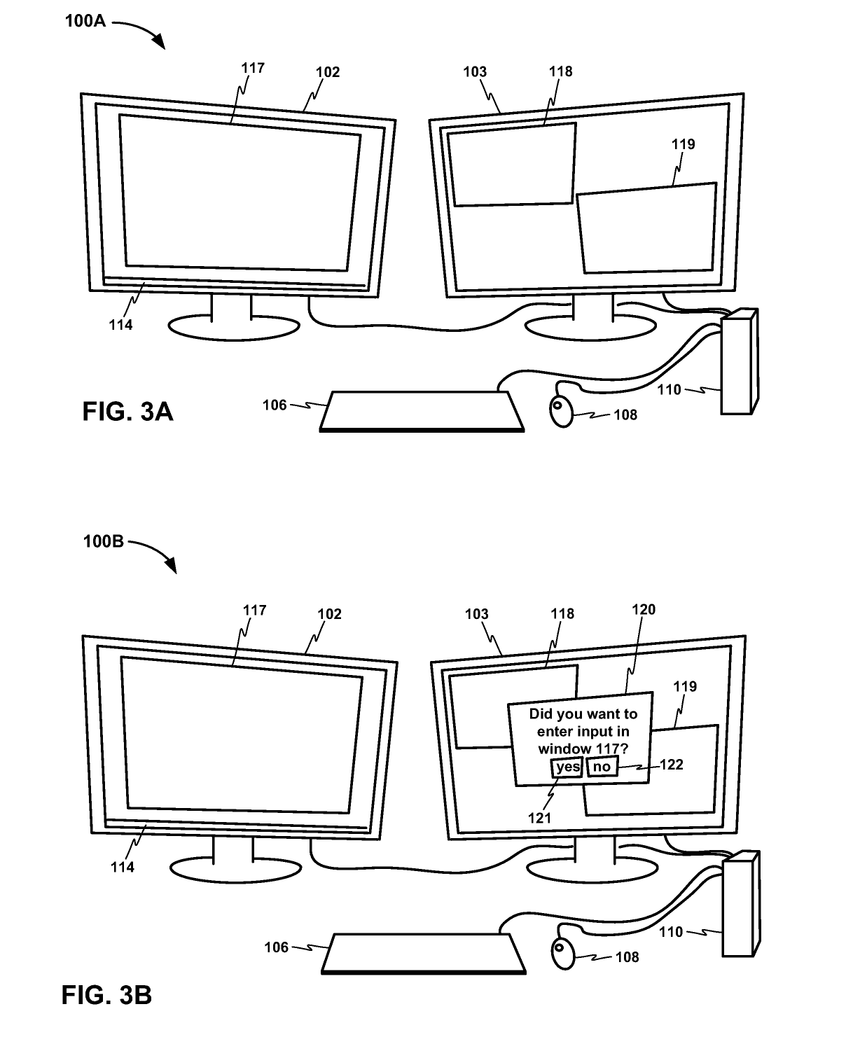

FIGS. 3A and 3B depict a personal computing environment running a user input guidance agent, according to an illustrative example. FIGS. 3A and 3B show a user's computing environment 100A and 100B, respectively, which show the same computing environment in different states during the operation of a user input guidance agent (such as user input guidance agent 90 of FIG. 2), in one example. Computing environment 100A includes a computing device 110 with two monitors 102, 103 operatively connected thereto. Monitor 102 displays a taskbar 114 as a graphical user interface element for the user to interact with an operating system of computing device 110. Monitor 102 also displays a computer program user interface 117 as a computer program user interface for computer program 87. Monitor 103 displays computer program user interface 118 for computer program 88 and computer program user interface 119 for computer program 89. Computer program user interfaces 117, 118, 119 are in the form of user interface windows in this example.

A user may select any of the computer program user interfaces 117, 118, 119 to bring into focus at a given time, so that the respective computer program, from among computer programs 87, 88, and 89, associated with the in-focus window is configured as the default destination to receive user inputs. A user may enter those user inputs through user input devices such as a keyboard 106 and a mouse 108, which are operatively connected to computing device 110. The user may select one of computer program user interfaces 117, 118, 119 to bring into focus by, for example, clicking on it with an on-screen pointer guided by mouse 108, or by pressing alt-tab on keyboard 106 to shift focus between the GUI elements, for example.

The various elements of computing environment 100A form a computing apparatus, or a part of a computing apparatus. The user input devices in various embodiments of a computing apparatus may include one or multiple user input devices and/or user input components, such as keyboard 106 and/or mouse 108. In another example, the user input device may include additional user input devices, such as a touchscreen running an on-screen keyboard application, a touchscreen configured to receive touch inputs as pointer inputs, a trackpad, a trackball, an on-keyboard peg-style integrated pointer device, a microphone and a voice user interface computer program that translates voice user inputs into the equivalent of keyboard inputs and/or pointer inputs, or any other type of device, component, or combination of hardware and software that is configured to be able to receive user inputs.

The user inputs entered to computer program user interfaces 117, 118, 119, via keyboard 106 and mouse 108 may generally be provided to the corresponding computer programs 87, 88, 89 running on computing device 110, subject to the intervention of user input guidance agent 90, as shown in FIG. 2. Computing device 110, executing user input guidance agent 90, may record, in one or more computer-readable tangible storage devices, user inputs as recorded user inputs associated with each of one or more of computer program user interfaces 117, 118, and 119 of computer programs 87, 88, and 89, respectively, through one of the processes discussed above, such as analyzing user interaction history, or receiving user designations of certain user inputs with corresponding computer program user interfaces.

Subsequently, the user may be using computing device 110, which may have computer programs 87, 88, and 89 as pictured in FIG. 2 running on it. Computing device 110 is an example of computing device 40 of FIG. 1 and may have one or more processors, as discussed with reference to processor unit 44 of FIG. 1, and at least one of those one or more processors of computing device 110 may be executing any of computer programs 87, 88, and 89, and providing a display output to one or more of monitors 102 and 103 or other display devices. This display output may include any one or more of computer program user interface 117 for computer program 87, computer program user interface 118 for computer program 88, computer program user interface 119 for computer program 89, or any additional computer program user interfaces.

The user may alternate intermittently between computer program user interfaces 117, 118, 119 to shift between interacting with the corresponding computer programs 87, 88, 89. A user may also pause momentarily from entering any inputs while the user views content in one or more of computer program user interfaces 117, 118, 119. The user may also engage in other activities not directly involving computing environment 100A, or may get up from computing environment 100A and then later return to computing environment 100A, for example. In any of these or a variety of other ways, the user may lose track of which of computer program user interfaces 117, 118, 119 is in focus.

For example, computing device 110 may receive a current user input via one of the user input devices, such as keyboard 106, while user computer program user interface 118 is currently in focus, i.e., is currently configured to receive user inputs via keyboard 106, and after computer program user interface 117 was previously in focus and configured to receive user inputs via keyboard 106. At least one of the one or more processors of computing device 110, executing user input guidance agent 90, monitors the user inputs and determines whether the current user input matches any of the recorded user inputs, as previously recorded with indicated associations with particular computer program user interfaces. This function of monitoring the user inputs and determining whether the current user input matches any of the recorded user inputs, and other functions performed by user input guidance agent 90 executing on computing device 110, may equivalently be attributed to being performed by computing device 110 or at least one processor thereof.

In one illustrative example, user input guidance agent 90 determines that the current user input matches a recorded user input for entering in computer program user interface 117 of computer program 87. In response to computing device 110, executing user input guidance agent 90, determining that the current user input matches a recorded user input for entering in computer program user interface 117 of computer program 87, computing device 110 prevents the current user input from being received by computer program user interface 118 for computer program 88, as it normally would receive user inputs entered when computer program user interface 118 is in focus, and instead provides the current user input to computer program user interface 117 for computer program 87. This may be done with user inputs entered via keyboard 106, as well as input behaviors with mouse 108 or other pointer device, where common user inputs may be recorded and analyzed that are specific to a given computer program and user behavior, such as common mouse movements and clicks for computer-aided design (CAD) computer programs, for example.

As shown in FIG. 3B, computing device 110 executing user input guidance agent 90 may also display a prompt 120, after preventing the current user input from being received by computer program 88 and before the providing the current user input to computer program 87. Prompt 120 has a user-selectable option 121 to provide the current user input to computer program user interface 117 for computer program 87, and another user-selectable option 122 to provide the current user input to computer program user interface 118 for computer program 88, as would have happened without the intervention of user input guidance agent 90. User input guidance agent 90 may then provide the current user input to computer program 87 in response to receiving a user input indicating selection of user-selectable option 121 to provide the current user input to computer program user interface 117 for computer program 87.

User input guidance agent 90 may also provide a user-selectable option for whether to display prompt 120 before preventing the current user input from being received by one computer program user interface and providing the current user input to another computer program user interface, or whether to proceed directly, without requiring prompt 120, with preventing the current user input from being received by one computer program user interface and providing the current user input to another computer program user interface as indicated by the recorded user inputs and corresponding associated computer program user interfaces.

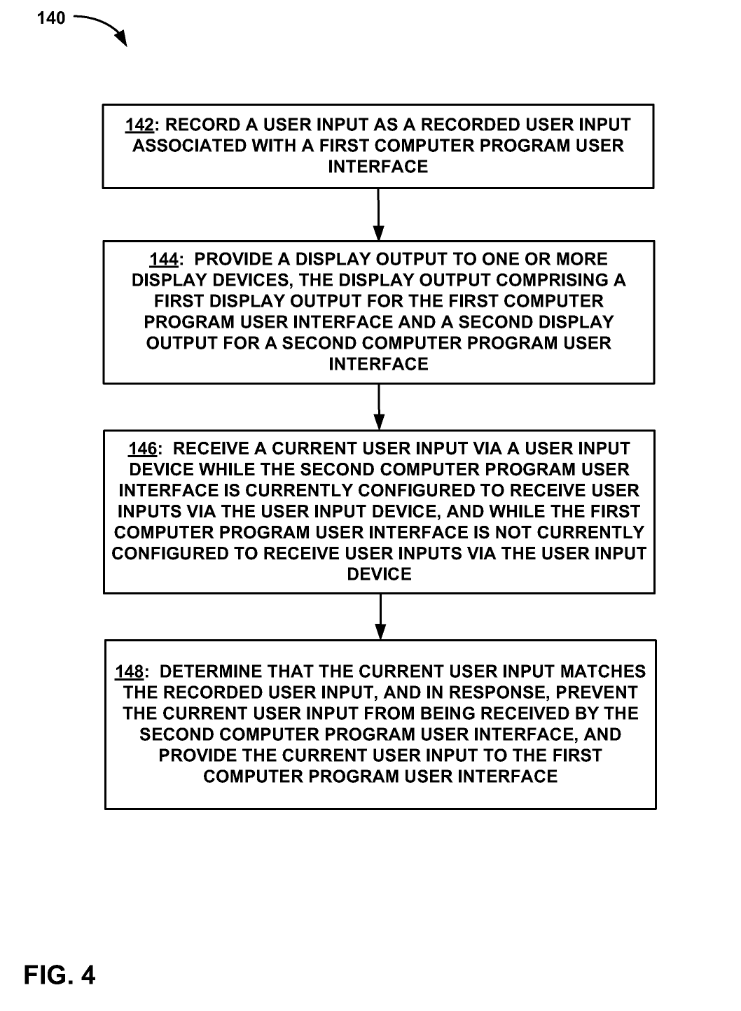

FIG. 4 is a flowchart illustrating operation of a method for a user input guidance agent, such as user input guidance agent 90 of FIG. 2, according to an illustrative example. Method 140 may include functions encoded in executable instructions stored as part of program code 64 in computer program product 60 in FIG. 1, and which also may be stored in persistent data storage 48, loaded into memory 46, and executed by processor unit 44 of FIG. 1, according to an illustrative example. Method 140 may be performed by a computing device, such as computing device 40 of FIG. 1, computing device 80 of FIG. 2, or computing device 110 of FIG. 3, including by one or more processors of a computing device carrying out computer-executable instructions embodied in a user input guidance agent (such as user input guidance agent 90 of FIG. 2) and/or associated computer-executable instructions, all of which may be referred to here as being performed by a computing device.

In this example, the computing device records a user input as a recorded user input associated with a first computer program user interface (142). The computing device provides a display output to one or more display devices, the display output comprising a first display output for the first computer program user interface and a second display output for a second computer program user interface (144). The computing device receives a current user input via a user input device while the second computer program user interface is currently configured to receive user inputs via the user input device, and while the first computer program user interface is not currently configured to receive user inputs via the user input device (146). The computing device determines whether the current user input matches the recorded user input, and in response to the computing device determining that the current user input matches the recorded user input, the computing device prevents the current user input from being received by the second computer program user interface, and provides the current user input to the first computer program user interface (148).

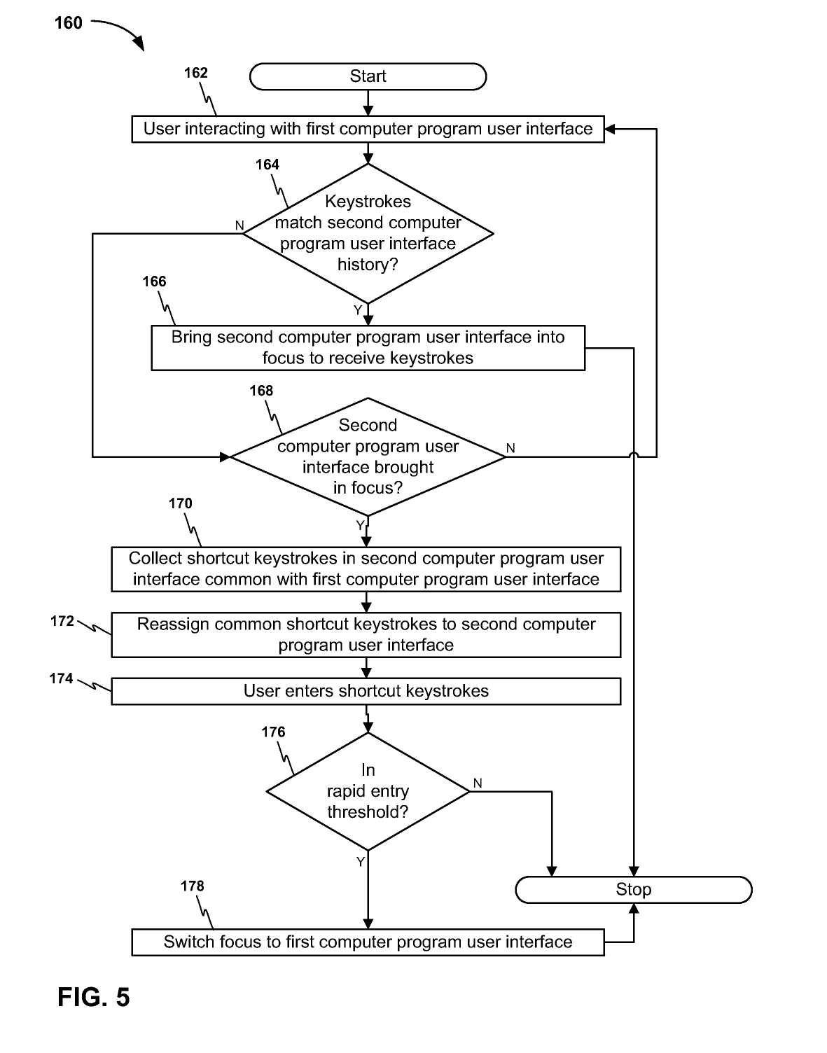

FIG. 5 is a flowchart illustrating operation of a method for a user input guidance agent, such as user input guidance agent 90 of FIG. 2, according to an illustrative example. Method 160 may include functions encoded in executable instructions stored as part of program code 64 in computer program product 60 in FIG. 1, and which also may be stored in persistent data storage 48, loaded into memory 46, and executed by processor unit 44 of FIG. 1, according to an illustrative example. Method 140 may be performed by a computing device, such as computing device 40 of FIG. 1, computing device 80 of FIG. 2, or computing device 110 of FIG. 3, or any other computing system, including by one or more processors of a computing device, carrying out computer-executable instructions embodied in a user input guidance agent (such as user input guidance agent 90 of FIG. 2) and/or associated computer-executable instructions, all of which may be referred to here as being performed by a computing device.

The example of FIG. 5 may involve a user input guidance agent recording and monitoring for user inputs for multiple different computer program user interfaces, as well as combining a threshold period of time within the user switching the focus with monitoring for recorded user inputs recorded in association with certain computer program user interfaces. In this example, the computing device enables a user to interact with a first computer program user interface (162). The computing device monitors user inputs such as keystrokes, including simultaneous and/or sequential combinations of keystrokes, and determines whether the one or more keystrokes match one or more recorded keystrokes recorded in association with a second computer program user interface (164). If the computing device determines that the one or more keystrokes match one or more recorded user inputs for the second computer program user interface, the computing device brings the second computer program user interface into focus to receive the one or more keystrokes (166). If the computing device determines that the one or more keystrokes do not match one or more recorded keystrokes for the second computer program user interface, the computing device may also monitor whether the user brings the second computer program user interface into focus (168). If not, the computing device continues enabling the user to interact with the first computer program user interface (162). If the user does bring the second computer program user interface into focus, the computing device may collect recorded user inputs, such as shortcut keystrokes, in the second computer program user interface that are in common with the first computer program user interface (170) and reassign the common shortcut keystrokes to the second computer program user interface (172). If the user then enters one or more shortcut keystrokes (174), the computing device may evaluate whether that shortcut keystroke user input was entered within a rapid entry threshold, i.e., a threshold period of time within the user switching focus between the first and second computer program user interfaces (176). If so, the computing device may determine that the user inputs were likely intended for entry into the first computer program user interface, and switch the focus back to the first computer program user interface (178).

In this and other examples, user input guidance agent 90 may record user inputs associated with multiple different computer program user interfaces, and monitor current user inputs to determine whether they match any recorded user inputs associated with any computer program user interfaces. In response to the user input guidance agent 90 determining that any current user input matches any of the recorded user inputs associated with a computer program user interface that is open but not currently in focus, user input guidance agent 90 may accordingly prevent that current user input from being received by the computer program user interface currently in focus, and instead provide the current user input to whatever computer program user interface is indicated by the recorded user input.

In particular, a user input guidance agent 90 may record a second user input associated with a second computer program user interface. When the user input guidance agent 90 receives a current user input via a user input device while the second computer program user interface is currently in focus, i.e., configured to receive user inputs via the user input device, and while the first computer program user interface is currently not configured to receive user inputs via the user input device, the user input guidance agent 90 may determine whether the second current user input matches the second recorded user input associated with the second computer program user interface, as well as determining whether the second current user input matches the first recorded user input associated with the first computer program user interface.

In response to the user input guidance agent 90 determining that the current user input matches both the second recorded user input associated with the second computer program user interface and the first recorded user input associated with the first computer program user interface, the user input guidance agent 90 may evaluate a relative likelihood of the current user input being intended for entry into the second computer program user interface or the first computer program user interface. That is, the user input guidance agent 90 may evaluate the relative likelihood in terms of the likelihood that the current user input was intended for entry into the second computer program user interface, relative to the likelihood that the current user input was intended for entry into the first computer program user interface. Then, in response to the user input guidance agent 90 evaluating that the relative likelihood is for the current user input being intended for entry into the second computer program user interface, the user input guidance agent 90 provides the current user input to the second computer program user interface. On the other hand, in response to the user input guidance agent 90 evaluating that the relative likelihood is for the current user input being intended for entry into the first computer program user interface, then the user input guidance agent 90 prevents the current user input from being received by the second computer program user interface, and provides the current user input instead to the first computer program user interface.

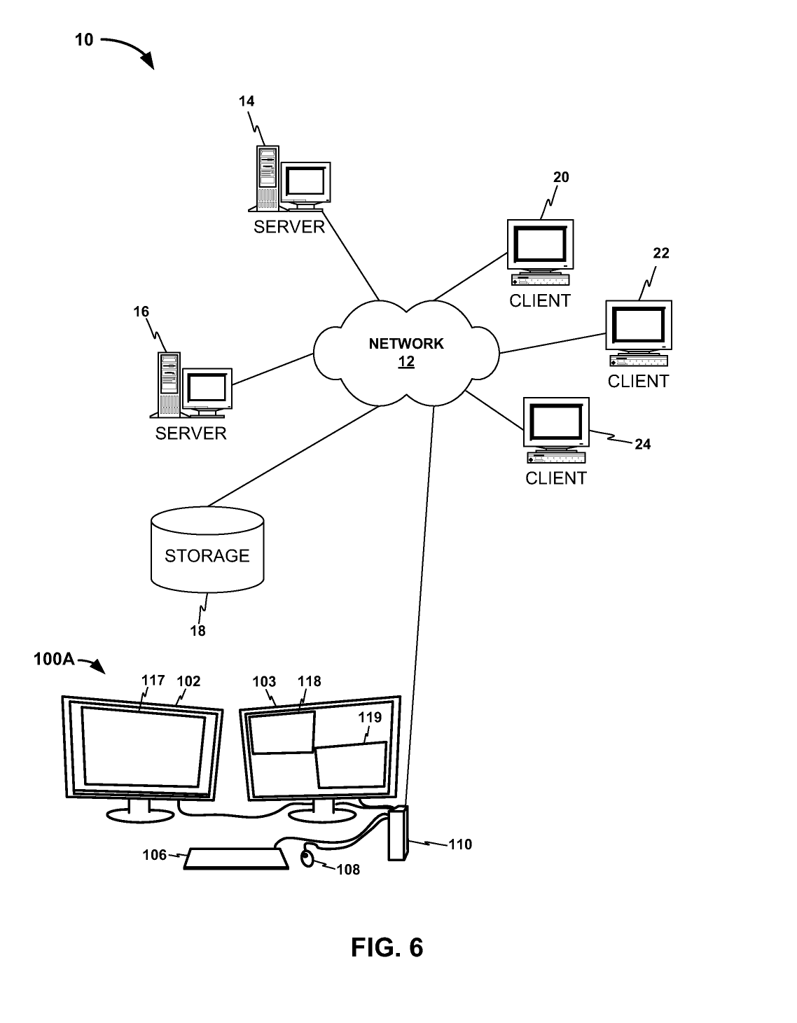

FIG. 6 is a block diagram of a computing network environment in which a user input guidance agent may be used, according to an illustrative example. FIG. 6 depicts a representation of a network of computer systems including one or more computing devices that implement, execute, or embody a user input guidance agent, such as user input guidance agent 90 of FIG. 2.

Computing environment 10 includes network 12. Network 12 may include one or more networks of any kind that may provide communications links between various devices and computers connected together within computing environment 10. Network 12 may include connections, such as wire, wireless communication links, or fiber optic cables. In the depicted example, server 14 and server 16 connect to network 12 along with storage unit 18. In one example, network 12 is the Internet with a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Network 12 may also be implemented as a number of different types of networks, such as for example, an intranet, a local area network (LAN), or a wide area network (WAN). FIG. 6 is an illustrative example, and not an architectural limitation for the variety of illustrative examples.

Servers 14 and 16 may include any type of servers, and storage unit 18 may include any type of storage device, storage server, storage area network, redundant array of independent discs (RAID), cloud storage service, or any other type of data storage. In addition, clients 20, 22, and 24 connect to network 12. Clients 20, 22, and 24 may be, for example, personal computers or network computers. In the depicted example, server 14 provides data, such as boot files, operating system images, and applications to clients 20, 22, and 24. Clients 20, 22, and 24 are clients to server 14 in this example. Computing environment 10 may include additional servers, clients, and other devices not shown.

Computing environment 10 also includes computing environment 100A, as depicted in FIG. 3A, with computing device 110 being connected to network 12. Computing environment 100A also includes user input devices in the form of keyboard 106 and mouse 108, and monitors 102 and 103 displaying computer program user interfaces 117, 118, and 119 for computer programs running on computing device 110, as shown in FIG. 3A. One or more of computer program user interfaces 117, 118, and 119 may be a web browser that is running a web application hosted by one of servers 14 or 16, and which may make use of data, such as recorded user inputs and indicated computer programs with which they have matches or associations, recorded locally on the same server or in a remote location such as storage 18, for example.

A user input guidance agent, such as user input guidance agent 90 of FIG. 2, may be used in a multi-desktop environment within computing environment 10, in one example. In this example, the user input guidance agent may run on computing device 110, while the user may make use of it not only in its local desktop environment of computing environment 100A but also on one or more virtual desktops running remotely on one or more of clients 20, 22, and 24, for example. The user input guidance agent may apply the same methods of monitoring user inputs among multiple computer program user interfaces among any number of desktop environments or user interface environments, to determine whether user inputs should be conveyed to currently in focus computer program user interfaces, or to prevent user inputs from being received by currently in focus computer program user interfaces and instead send the user inputs to different computer programs running on computing device 110 as indicated by matches between a current user input and a recorded user input having an associated computer program user interface.

A user input guidance agent, such as user input guidance agent 90 of FIG. 2, may also be used in computing environment 10 in a keyboard-video-mouse (KVM) system. In an example of this type of system, a user may use the single keyboard 106 and mouse 108 to provide input to multiple computers, such as clients 20, 22, and 24, and servers 14 and 16, in addition to computing device 110. The user input guidance agent may then monitor for which computer program user interface a user input is likely intended to be entered to, regardless of which particular computing device throughout computing environment 10 any given computer program user interface or associated computer program may be provided from, executed on, or stored on, among any computer to which computing environment 100A has access to through the KVM system.

In particular, in this KVM system example, user interface devices of a user's computing environment 100A, such as monitors 102 and 103, may be in operative connection with a second computing device and a third computing device, such as client 20 and server 14. Monitor 103 may display a first computer program user interface 118 and a second computer program user interface 119, where computer program user interface 118 is for a first computer program executing on client 20, and computer program user interface 119 is for a second computer program executing on server 14. A user may then enter a user input on keyboard 106, that is received by a user input guidance agent running on computing device 110, while computer program user interface 119 is currently in focus. In response to the user input guidance agent determining that the current user input matches a recorded user input associated with computer program user interface 118, the user input guidance agent prevents the current user input from being provided to computer program user interface 119 for the computer program running on server 14, and instead provides the current user input to computer program user interface 118 for the computer program running on client 20.

A user input guidance agent, such as user input guidance agent 90 of FIG. 2, may also run on any of servers 14, 16 or client machines 20, 22, 24 of FIG. 6, or any other computing device, and monitor and provide guidance to user inputs and focus between computer program user interfaces for computer programs running on the computing device. Any of servers 14, 16, client machines 20, 22, 24, or computing environment 10 as a whole, as shown in FIG. 6, may be considered a computing system that may implement or embody a user input guidance agent, such as user input guidance agent 90 of FIG. 2.

In another illustrative example, a user input guidance agent, such as user input guidance agent 90 of FIG. 2, may also take contextual information about a computer program user interface into account as part of determining whether a current user input is likely intended for entry into the currently in-focus computer program user interface or a currently out-of-focus computer program user interface. In this example, a computing device, such as computing device 40 (FIG. 1) or computing device 110 (FIG. 3) records user inputs as recorded user inputs associated with the first computer program user interface of a first computer program in a way that includes analyzing the recorded user input in comparison with contextual information about the first computer program user interface. The user input guidance agent may then determine that the recorded user input has characteristics that are above a threshold of likelihood, in comparison with the contextual information about the first computer program user interface, of being associated with the first computer program user interface. A particular computer program user interface may also provide a list of keystroke sequences or other user inputs that are likely to be commonly used with the computer program user interface, and the user input guidance agent may simply read and record these commonly used keystroke sequences or other user inputs from the computer program user interface as recorded user inputs.

As a particular example, a first computer program user interface may include a text editor. A current user input may be received that includes an element of text. The user input guidance agent may then determine whether the current user input matches the recorded user input in a way that includes determining that the element of text is associated with a current subject of the first text editor. For example, if the text editor is being used to write a computer program in a certain programming language, such as Python, and then a sequence of user inputs is received that the user input guidance agent detects has improper Python syntax, this may trigger the user input guidance agent to divert the current user input to the previously in-focus computer program user interface, or to determine whether the current user input matches any recorded user inputs for any other currently open but out of focus computer program user interfaces.

As another example, a text editor, such as the text editor “vi”, that uses keystroke sequences for commands to move the cursor, change words, etc., may provide a list of common keystroke sequences in vi. The user input guidance agent may read the keystroke sequences indicated by vi to be commonly used within vi, and record those keystroke sequences as recorded user inputs, and also use these recorded input sequences for analyzing whether later user inputs are likely to be intended for use within vi. The user input guidance agent may combine and compare the user inputs read and recorded directly from what vi indicates as specialized commands within vi with additional data recorded from inputs entered by a user in actual usage, to refine the agent's capability to determine whether current user inputs match recorded user inputs and to evaluate the relative likelihood of current user inputs being intended either for entry into the user interface for vi or for entry into another computer program user interface.

In other examples, a user input guidance agent, such as user input guidance agent 90 of FIG. 2, may evaluate other aspects of context between different computer program user interfaces that may include or be associated with text editors, word processing programs, web applications, or any other type of computer programs. For example, if a currently in-focus computer program user interface is for a text editor or word processing program is being used to write or edit a body of text determined by user input guidance agent to be associated with topic ABC, and another, currently out-of-focus text editor has a body of text associated with topic XYZ, and a user input is received that the user input guidance agent determines is associated with topic XYZ, then the user input guidance agent may automatically divert the current user input to the text editor with the body of text associated with topic XYZ, and may also keep the focus switched to that text editor.

While FIGS. 3A and 3B depict computer program user interfaces 117, 118, 119 in the form of separate user interface windows, a user input guidance agent, such as user input guidance agent 90 of FIG. 2, may equally well distinguish among user inputs intended for entry into web-based applications running within a web-based platform. For example, a user may interact with a first web-based application that serves as a platform for one or multiple additional web-based applications running within the first web-based application, and which have user interfaces such as application widgets running within the user interface of the platform application. This is also a scenario in which it is likely for a user at times to lose track of which computer program user interface is in focus and configured to receive user inputs, where it may be the user interface for the web-based platform itself or the user interface for an application running within the platform. In this case, the user input guidance agent may determine whether a current user input matches a recorded user input for either the platform application or the application running within the platform.

While FIG. 2 depicts the user input guidance agent 90 residing on computing device 80, a user input guidance agent may reside either on a client machine or on a server or other remote resource. For example, a user input guidance agent may run on a server where it may be included as part of, or in cooperation with, a web-based application executing on one or more servers, such as servers 14, 16 depicted in FIG. 6. The user input guidance agent may, for example, be incorporated as a module, a process, an object, a subroutine, or other part of a web-based application running on a server. In another example, the user input guidance agent may run as a separate program on the server or on a separate server from the web-based application. This configuration may allow the user input guidance agent to act independently of any one or more specific web-based applications, and instead be abstracted from the particulars of any particular web-based application and instead be deployed as a generalized tool for web-based data services. In this way, a user input guidance agent may be deployed from the server side or from a data center to serve multiple users or clients, any one of whom may be using multiple web-based data services.

Examples of a user input guidance agent that uses context data may incorporate similar contextual data tools and principles that are used and known in the art in association with applications such as speech-to-text programs and email sorting tools, for example.

As will be appreciated by one skilled in the art, aspects of the present invention may be embodied as a device, a system, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable data storage devices or computer-readable data storage components that include computer-readable medium(s) having computer readable program code embodied thereon. For example, a computer-readable data storage device may be embodied as a tangible device that may include a tangible, non-transitory data storage medium, as well as a controller configured for receiving instructions from a resource such as a central processing unit (CPU) to retrieve information stored at one or more particular addresses in the tangible, non-transitory data storage medium, and for retrieving and providing the information stored at those particular one or more addresses in the data storage medium.

The data storage device may store information that encodes both instructions and data, for example, and may retrieve and communicate information encoding instructions and/or data to other resources such as a CPU, for example. The data storage device may take the form of a main memory component such as a hard disc drive or a flash drive in various embodiments, for example. The data storage device may also take the form of another memory component such as a RAM integrated circuit or a buffer or a local cache in any of a variety of forms, in various embodiments. This may include a cache integrated with a controller, a cache integrated with a graphics processing unit (GPU), a cache integrated with a system bus, a cache integrated with a multi-chip die, a cache integrated within a CPU, or the processor registers within a CPU, as various illustrative examples. The data storage apparatus or data storage system may also take a distributed form such as a redundant array of independent discs (RAID) system or a cloud-based data storage service, and still be considered to be a data storage component or data storage system as a part of or a component of an embodiment of a system of the present disclosure, in various embodiments.

Any combination of one or more computer readable medium(s) may be utilized. The computer readable medium may be a computer readable signal medium or a computer readable storage medium. A computer readable storage medium may be, for example, but is not limited to, an electronic, magnetic, optical, electromagnetic, infrared, electro-optic, heat-assisted magnetic, or semiconductor system, apparatus, or device, or any suitable combination of the foregoing. More specific examples (a non-exhaustive list) of the computer readable storage medium would include the following: an electrical connection having one or more wires, a portable computer diskette, a hard disc, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device, for example.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to radio frequency (RF) or other wireless, wireline, optical fiber cable, etc., or any suitable combination of the foregoing.

Computer program code for carrying out operations for aspects of the present invention may be written in any combination of one or more programming languages, including an object oriented programming language such as Java, Smalltalk, C++, Objective-C, or the like, or other imperative programming languages such as C, or functional languages such as Common Lisp, Haskell, or Clojure, or multi-paradigm languages such as C#, Python, Ruby, or Scala, among a variety of illustrative examples. One or more sets of applicable program code may execute partly or entirely on the user's desktop or laptop computer, smartphone, tablet, or other computing device; as a stand-alone software package, partly on the user's computing device and partly on a remote computing device; or entirely on one or more remote servers or other computing devices, among various examples. In the latter scenario, the remote computing device may be connected to the user's computing device through any type of network, including a local area network (LAN) or a wide area network (WAN), or the connection may be made to an external computer (for example, through the Internet using an Internet Service Provider).

For example, in various illustrative embodiments, various computer programs, software applications, modules, or other software elements may be executed in connection with one or more user interfaces being executed on a client computing device, that may also interact with one or more web server applications that may be running on one or more servers or other separate computing devices and may be executing or accessing other computer programs, software applications, modules, databases, data stores, or other software elements or data structures. A graphical user interface may be executed on a client computing device and may access applications from the one or more web server applications, for example. Various content within a browser or dedicated application graphical user interface may be rendered or executed in or in association with the web browser using any release version of HTML, CSS, JavaScript, XML, AJAX, JSON, and various other languages or technologies, while other content may be provided by computer programs, software applications, modules, or other elements executed on the one or more web servers and written in any programming language and/or using or accessing any computer programs, software elements, data structures, or technologies, in various illustrative embodiments.

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, may create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices, to produce a computer implemented process such that the instructions which execute on the computer or other programmable apparatus provide or embody processes for implementing the functions/acts specified in the flowchart and/or block diagram block or blocks.

The flowchart and block diagrams in the figures illustrate the architecture, functionality, and operation of possible implementations of devices, methods and computer program products according to various embodiments of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may be executed in a different order, depending upon the functionality involved. Each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

The description of the present disclosure has been presented for purposes of illustration and description, and is not intended to be exhaustive or limited to the disclosure in the form disclosed. Many modifications and variations will be understood by those of ordinary skill in the art based on the concepts disclosed herein. The particular examples described were chosen and disclosed in order to explain the principles of the disclosure and example practical applications, and to enable others of ordinary skill in the art to understand the disclosure for various embodiments with various modifications as are suited to the particular use contemplated. The various examples described herein and other embodiments are within the scope of the following claims.

What is claimed is:

1. A method comprising:
a computing device recording, in one or more computer-readable tangible storage devices, a user input as a recorded user input associated with a first computer program user interface;
at least one of one or more processors of the computing device providing a display output to one or more display devices, the display output comprising a first display output for the first computer program user interface and a second display output for a second computer program user interface;
the computing device receiving a current user input via a user input device while the second computer program user interface is currently configured to receive user inputs via the user input device, and while the first computer program user interface is not currently configured to receive user inputs via the user input device;
the at least one of the one or more processors of the computing device determining that the current user input matches the recorded user input, and in response, the at least one of the one or more processors of the computing device preventing the current user input from being received by the second computer program user interface, and the at least one of the one or more processors of the computing device providing the current user input to the first computer program user interface.

2. The method of claim 1, further comprising displaying a prompt, after the preventing the current user input from being received by the second computer program user interface and before the providing the current user input to the first computer program user interface, wherein the prompt has a user-selectable option to provide the current user input to the first computer program user interface and a user-selectable option to provide the current user input to the second computer program user interface, wherein the providing the current user input to the first computer program user interface is done in response to receiving a user input indicating selection of the user-selectable option to provide the current user input to the first computer program user interface.

3. The method of claim 1, further comprising providing a user-selectable option for whether to display a prompt before preventing the current user input from being received by the second computer program user interface and providing the current user input to the first computer program user interface, or whether to proceed, without requiring a prompt, with preventing the current user input from being received by the second computer program user interface and providing the current user input to the first computer program user interface.

4. The method of claim 1, wherein the recorded user input is a first recorded user input, and the current user input is a first current user input, the method further comprising:
the computing device recording, in at least one of the one or more computer-readable tangible storage devices, a second user input as a second recorded user input associated with the second computer program user interface;
the computing device receiving a second current user input via the user input device while the first computer program user interface is currently configured to receive user inputs via the user input device;
the at least one of the one or more processors of the computing device determining that the second current user input matches the second recorded user input, and in response, the at least one of the one or more processors of the computing device preventing the second current user input from being received by the first computer program user interface, and providing the current user input to the second computer program user interface.

5. The method of claim 1, further comprising:
the at least one of the one or more processors of the computing device measuring a frequency with which various user inputs are entered to the first computer program user interface over time; and
the at least one of the one or more processors of the computing device identifying one of the various user inputs as being received with a frequency that exceeds a threshold;
wherein the computing device recording, in the at least one of the one or more computer-readable tangible storage devices, the user input as the recorded user input associated with the first computer program user interface comprises the at least one of the one or more processors of the computing device recording the one of the various user inputs that is received with the frequency that exceeds the threshold as the recorded user input associated with the first computer program user interface.

6. The method of claim 1, further comprising the computing device recording, in the at least one of the one or more computer-readable tangible storage devices, a user input indicating selection of a user-selectable option to enter the current user input in the first computer program user interface, regardless of whether the first computer program user interface is currently configured to receive user inputs via the user input device.

7. The method of claim 1, wherein determining that the current user input matches the recorded user input comprises determining that the first computer program user interface was configured to receive user inputs via the user input device within a threshold range of time prior to the second computer program user interface being configured to receive user inputs.

8. The method of claim 1, further comprising:
the computing device analyzing the recorded user input in comparison with contextual information about the first computer program user interface; and
the computing device determining that the recorded user input has characteristics that are above a threshold of likelihood, in comparison with the contextual information about the first computer program user interface, of being associated with the first computer program user interface.

9. The method of claim 1,
wherein the first computer program user interface comprises a first text editor;
wherein the current user input comprises an element of text; and
wherein the determining whether the current user input matches the recorded user input comprises determining that the element of text is associated with a current subject of the first text editor.

10. The method of claim 1, wherein the recorded user input comprises a sequence of user inputs, and wherein determining that the current user input matches the recorded user input comprises determining that the sequence of user inputs was entered via the user input device in a period of time within a range of periods of time for the sequence of user inputs to be received, as stored in association with the recorded user input.

11. The method of claim 1, wherein the recorded user input is a first recorded user input and the current user input is a first current user input, the method further comprising:
the computing device recording, in at least one of the one or more computer-readable tangible storage devices, a second user input as a second recorded user input associated with the second computer program user interface;
the computing device receiving a second current user input via a user input device while the second computer program user interface is currently configured to receive user inputs via the user input device, and while the first computer program user interface is not currently configured to receive user inputs via the user input device;
the at least one of the one or more processors of the computing device determining that the second current user input matches the second recorded user input associated with the second computer program user interface and that the second current user input matches the first recorded user input associated with the first computer program user interface, and in response, the at least one of the one or more processors of the computing device evaluating a relative likelihood of the current user input being intended for entry into the second computer program user interface or the first computer program user interface; and
in response to the relative likelihood being that the current user input is intended for entry into the second computer program user interface, the at least one of the one or more processors of the computing device providing the current user input to the second computer program user interface.

12. The method of claim 1, wherein the computing device comprises a user interface device in operative connection with a second computing device and a third computing device, wherein the user interface device displays the first computer program user interface and the second computer program user interface, the first computer program user interface is a user interface for a first computer program that executes on the second computing device, and the second computer program user interface is a user interface for a second computer program that executes on the third computing device, the method further comprising:
the user input device receiving the current user input; and
in response to determining that the current user input matches the recorded user input, the at least one of the one or more processors of the computing device preventing the current user input from being provided to the third computing device, and the at least one of the one or more processors providing the current user input to the second computing device and to the first computer program user interface for the first computer program executing on the second computing device.

13. The method of claim 1, wherein the first computer program user interface is a user interface for a first computer program, and the second computer program user interface is a user interface for a second computer program.

14. The method of claim 1, wherein the first computer program user interface is a user interface for a first instance of a first computer program, and the second computer program user interface is a user interface for a second instance of the first computer program.

15. The method of claim 1, wherein the recorded user input is associated with accessing a feature of the first computer program user interface, and wherein the method further comprises the computing device accessing the feature of the first computer program user interface in response to receiving the provided current user input.

16. The method of claim 1, wherein the user input device comprises a keyboard, and wherein the current user input comprises a keystroke or a combination of keystrokes on the keyboard.

17. The method of claim 1, wherein the first computer program user interface and the second computer program user interface each comprise a graphical user interface window.

18. The method of claim 1, wherein the display output further comprises a graphical window including a first and second tabs, the first tab including the first computer program user interface and the second tab including the second computer program user interface.

19. A computing system comprising:
one or more processors;
one or more computer-readable tangible storage devices;
one or more display devices;
one or more user input devices;
program instructions, stored on at least one of the one or more computer-readable tangible storage devices for execution by at least one of the one or more processors, to record, in at least one of the one or more computer-readable tangible storage devices, a user input as a recorded user input associated with a first computer program user interface;
program instructions, stored on at least one of the one or more computer-readable tangible storage devices for execution by at least one of the one or more processors, to provide a display output to at least one of the one or more display devices, the display output comprising a first display output for the first computer program user interface and a second display output for a second computer program user interface;
program instructions, stored on at least one of the one or more computer-readable tangible storage devices for execution by at least one of the one or more processors, to receive a current user input via at least one of the one or more user input devices while the second computer program user interface is currently configured to receive user inputs via the at least one of the one or more user input devices, and while the first computer program user interface is not currently configured to receive user inputs via the at least one of the one or more user input devices;
program instructions, stored on at least one of the one or more computer-readable tangible storage devices for execution by at least one of the one or more processors, to determine that the current user input matches the recorded user input, and in response, to prevent the current user input from being received by the second computer program user interface and to provide the current user input to the first computer program user interface.

20. A computer program product comprising:
one or more computer-readable tangible storage devices;
program instructions, stored on at least one of the one or more computer-readable tangible storage devices, to record, in at least one of the one or more computer-readable tangible storage devices, a user input as a recorded user input associated with a first computer program user interface;
program instructions, stored on at least one of the one or more computer-readable tangible storage devices, to provide a display output to at least one of one or more display devices, the display output comprising a first display output for the first computer program user interface and a second display output for a second computer program user interface;
program instructions, stored on at least one of the one or more computer-readable tangible storage devices, to receive a current user input via at least one of one or more user input devices while the second computer program user interface is currently configured to receive user inputs via the at least one of the one or more user input devices, and while the first computer program user interface is not currently configured to receive user inputs via the at least one of the one or more user input devices;
program instructions, stored on at least one of the one or more computer-readable tangible storage devices, to determine that the current user input matches the recorded user input, and in response, to prevent the current user input from being received by the second computer program user interface and to provide the current user input to the first computer program user interface.
